(19) United States
(12) Patent Application Publication
(10) Pub. No.: US 2024/0344501 A1
(43) Pub. Date: Oct. 17, 2024

(54) An Offshore Wind Turbine Installation with a Concrete-Cast Transition Piece Between the Wind Turbine Tower and its Support

(71) Applicant: Stiesdal Offshore A/S, Give (DK)

(72) Inventors: Henrik Stiesdal, Odense C (DK); Patrick Falk Nybroe, Solbjerg (DK)

(21) Appl. No.: 18/731,916

(22) Filed: Jun. 3, 2024

(30) Foreign Application Priority Data
Dec. 7, 2021 (DK) PA 2021 01159

(51) Int. Cl. F03D 13/20; E04H 12/08; E04H 12/20; F03D 13/25

(52) U.S. Cl. CPC F03D 13/205; E04H 12/085; E04H 12/20; F03D 13/25; F05B 2240/912; F05B 2240/95

(57) ABSTRACT

An offshore wind turbine installation comprising a wind turbine on a support structure. A concrete-cast transition piece is provided in between the tower of the wind turbine and a tower support of the support structure. Flanges of the tower and the tower support are either bolted to each other, sandwiching the transition piece in between, or bolted into the transition piece for fixation.

### CROSS-REFERENCE TO RELATED APPLICATIONS

This application is a continuation under 35 U.S.C. 111 of International Patent Application No. PCT/DK2022/050259, filed Dec. 5, 2022, which claims the benefit of and priority to Danish Application No. PA 2021 01159, filed Dec. 7, 2021, each of which is hereby incorporated by reference in its entirety.

### FIELD OF INVENTION

The present invention relates to an offshore wind turbine installation that comprises a wind turbine as well as a support structure for supporting the wind turbine, wherein a concrete-cast transition piece is provided in between the support structure and the tower of the wind turbine.

### BACKGROUND

Most commonly, a modern wind turbine consists mainly of a rotor and a tower and a nacelle that connects the rotor to the tower. For offshore wind turbine installations, the tower is erected on a support structure, which is either mounted onto the seabed or floating at or below the water surface. In order to fasten the tower to the corresponding offshore support structure, various forms for transition pieces are disclosed in the prior art.

European patent EP2011924 discloses a transition piece made of concrete, where the lower part of the transition piece has a cavity in which it accommodates the upper part of a monopile structure, which is embedded in the seabed. A portion of the transition piece is located below the waterline and another portion above. The consequence of the transition piece accommodating an upper portion of the monopile results in the transition piece having a large size and substantial length. This makes it heavy and implies a high level of costs for the production and challenges for the transport. Furthermore, water and sand are likely to enter in the region between the transition piece and the columns, with increased risk for wear and corrosion.

In international patent application WO2020/106146, a wind turbine structure is disclosed where the tower of the wind turbine is directly bolted to a monopile structure. The monopile has a conical uppermost portion, which is carrying a platform that is supported on a corresponding cooperating conical support. The platform is at a level that gives personal access to the bolts that are used to hold the tower to the monopile.

A conical top part of a monopile is also disclosed in international patent application WO2018/070868. In this case, the conical top part is used for holding a platform as well as accommodating the tower of the wind turbine.

US2012/0257973 discloses an offshore wind turbine having a concrete structure that encircles the tower and serves as container deck. WO2020/089020 discloses a wind turbine tower made of multiple sections that are fastened to each other by metal flanges. Chinese utility model CN212958956U discloses elastic transition pieces between tower sections. EP3064309A1 discloses a positioning device between a monopile structure and an offshore wind turbine. GB2419150A discloses a case joint for a wind turbine tower support base. GB2116237, U.S. Pat. Nos. 4,553,878 and 4,687,380 disclose various offshore tower constructions.

It would be desirable to have more options for transition pieces between a support structure and a wind turbine tower, which do not require monopiles with a conical top part and where risk for corrosion is reduced. It would also be desirable to have smaller transition pieces.

### BRIEF DESCRIPTION

It is therefore an objective of the present systems and methods to provide an improvement in the art. In particular, it is an objective to provide a transition piece between a support structure and a wind turbine tower which does not require a monopile with a conical top part so that the transition piece is more universal and has a broader range of use in connection with other support structures than monopiles, in particular including floating support structures for offshore wind turbines. It is also an objective to provide a transition piece that is relatively small in order to save costs and weight and to make the transport of the transition piece simple. A further objective is to provide a transition piece that is above the waterline for minimizing wear and corrosion. These objectives and further advantages are achieved with an offshore wind turbine installation as described below.

In short, an offshore wind turbine installation is provided, which comprises a wind turbine on a support structure. A concrete-cast transition piece is provided in between the tower of the wind turbine and a tower support, typically support column, of the support structure. Flanges of the tower and the tower support are either bolted to each other, sandwiching the transition piece in between, or bolted into the transition piece for fixation.

The wind turbine comprises a rotor on a tower, typically using a nacelle for holding a rotor with a horizontal rotation axle. For supporting the tower in offshore conditions, the offshore support structure comprises a tower support mounted to a frame. Typically, the tower support is provided as a support column, although, this is not strictly necessary. The tower support and the frame are part of the support structure.

The support structure is a floating support structure or a seabed-fixed support structure. Examples of floating structures comprise tetrahedral frames, in which the tower support is optionally located in a corner or in the center of the frame. However, also other polygonal structures are useful.

The tower support, for example support column, has a support flange at its upper end. Similarly, the tower has a tower flange at its lower end. Each of the support flange and the tower flange comprise holes for bolts extending through the flanges. A concrete-cast transition piece is provided between the support flange and the tower flange. A lower side of this transition piece is in mechanical contact and supported by an upper side of the support flange. On the other hand, a lower side of the tower flange is in mechanical contact with an upper side of the transition piece and supported by the transition piece, and thus, by the tower support. In other words, the tower is supported by the tower support with the transition piece in between.

The installation comprises bolts that are fastening the tower flange to the tower support flange with the transition piece in between.

In a first embodiment, each of the bolts is extending through both flanges and pulling the flanges towards each other with the transition piece sandwiched in between as a distance holder.

In other embodiments, a first number of the bolts is extending downwards through the tower flange into first threaded bushings that are embedded inside the concrete-cast transition piece, and a second number of the bolts is extending upwards through the support flange into second threaded bushings embedded inside the cast transition piece, so that the flanges are bolted to the transition piece, which is located in between the flanges.

Advantageously, the support flange and the tower flange each extend radially in a plane perpendicular to a central longitudinal axis of the tower. As a useful option, the bolts, which are extending through the holes in the flanges, are oriented with their longitudinal axis in parallel to the central axis of the tower. As the tower is typically vertically oriented during operation, unless pushed to an inclined orientation due to wind, the bolts extend vertically.

This principle of the transition piece is especially useful if the tower and the tower support, for example support column, do not have the same diameter. For example, the tower has a tower diameter Dt, and the support structure has a support diameter Ds that is larger or smaller than Dt.

For the connection, the following principle is useful, wherein the tower flange comprises a first number of holes along a first circle, typically on or close to a circle with diameter Dt, and the support structure comprises a second number of holes along a circle with a second diameter, which is different from the first diameter, typically on or close to a circle with diameter Dt.

The first number of the bolts extends from above the tower flange through the first number of holes in the tower flange and into a first number of cooperating bushings inside the transition piece. The second number of bolts extends from below the support flange through the second number of holes in the support flange and into a second number of cooperating bushings inside the transition piece. The bushings are embedded solidly inside the concrete material and optionally comprise sheer keys, for example wings, for solid connection to the concrete-cast transition piece.

As mentioned above, the floating structure optionally comprises a tetrahedral frame. In such case, in more detail, the support structure is formed with a triangular base to which the tower support is fixed and with diagonal braces extending from the triangular base towards the tower support. For example, the ends of the diagonal braces are embedded in concrete in a volume that is contained in the upper end of the tower support.

Typically, the tower support and the tower are steel columns, and the flanges are welded to the ends of the columns.

In some useful embodiments, the transition piece comprises a platform for workers. Such platform is provided on a platform support. Optionally, the platform support is an integral part of the transition piece. Alternatively, a platform frame is provided as part of the transition piece, for example provided as bars embedded in the concrete of the connector segment and extending horizontally outwards therefrom. In the latter case, a platform is established on the bars.

In useful embodiments, the height H of the transition piece, when measured in a direction parallel to the central axis of the tower is no more than half of the tower diameter and no more than half of the diameter of the tower support. This results in a transition piece that is relatively narrow and with relatively low volume.

### BRIEF DESCRIPTION OF THE DRAWINGS

The systems and methods will be explained in more detail with reference to the drawings, wherein:

FIG. 1 illustrates a semisubmersible wind turbine installation, according to an embodiment;

FIG. 2 illustrates a transition piece between a support structure and a tower of equal diameter, according to an embodiment;

FIG. 3 illustrates a transition piece for a support structure having a smaller diameter than the tower, according to an embodiment;

FIG. 4 illustrates a transition piece for a support structure having a larger diameter than the tower, according to an embodiment;

FIG. 5A illustrates a transition piece with lateral support bars for the platform and FIG. 5B is a top view of a transition piece, according to an embodiment;

FIG. 6A illustrates diagonal braces inserted into the tower support for a grout connection, and FIG. 6B shows details thereof, according to an embodiment.

### DETAILED DESCRIPTION

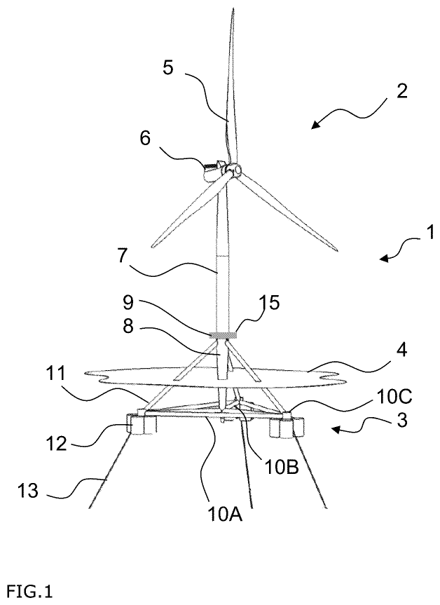

FIG. 1 illustrates an offshore wind turbine installation 1. The installation 1 comprises a wind turbine 2 and an offshore support structure 3, on which the wind turbine 2 is mounted and by which it is supported in offshore conditions. The wind turbine 2 comprises a rotor 5 and a tower 7 and nacelle 6 that connects the rotor 5 with the tower 7.

The offshore support structure 3 is exemplified as a semisubmersible structure with mooring lines 13 and buoyancy tanks 12 that keep the structure 3 floating half-way submersed under water. Alternatively, the structure could be a tension leg platform (TLP) with a fully submerged floating support structure or a bottom supported platform, for example a monopile.

The exemplified semisubmersible structure 3 comprises buoyancy tanks 12 that are interconnected in a triangular shape where the triangular base is formed by side braces 10A and radial braces 10B. The side braces 10A form a triangle by interconnection at corners 10C. The radial braces 10B connect the corners 10C to the tower support 8.

The tower support 8 is exemplified as a support column. On top of the support column 8, there is provided a transition piece 9, which optionally also comprises a workers' platform 15 that is accessible for workers when inspecting the wind turbine 2 and entering the tower 7.

In order to provide increased mechanical stability between the support column 8 and the triangular base, formed by the side braces 10A and the radial braces 101B, there are provided diagonal braces 11, which extend from the corners 10C to the upper portion of the support column 8, thereby forming a tetrahedron.

As illustrated, the tower support 8 extends to a position above the water surface 4, and correspondingly, also the transition piece 9 with the workers' platform 15 is located entirely above the water surface 4. The fact that the transition piece 9 is located above the water surface 4 reduces risk for wear and corrosion.

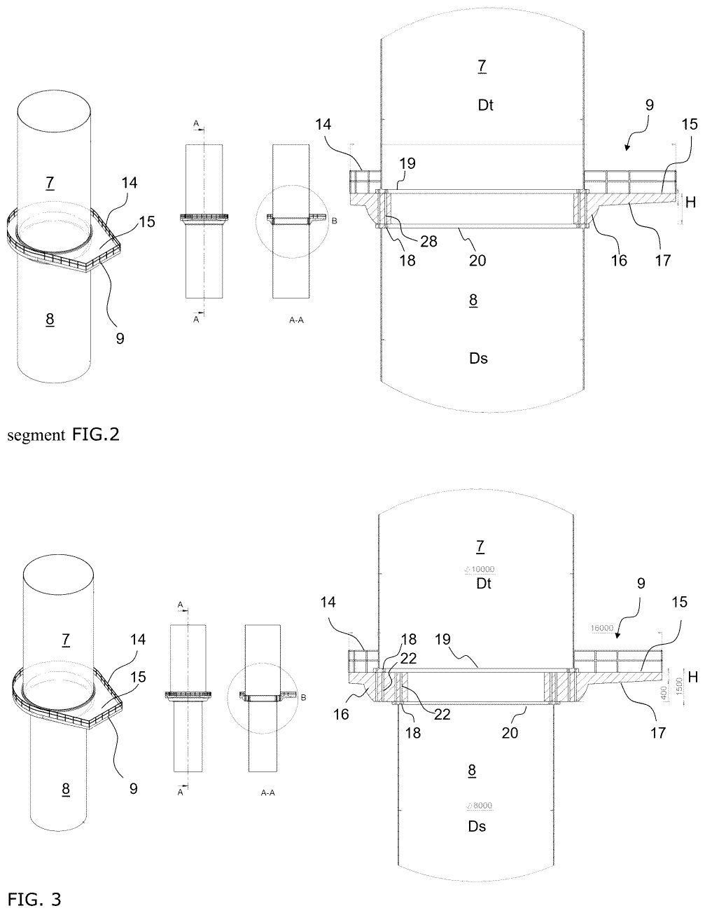

FIG. 2 illustrates a transition piece 9 between the tower support column 8 and the tower 7. Integrated in the transition piece 9 is the workers' platform 15 where workers can stand for inspection, as already mentioned. For safety, it is surrounded by a fence 14.

The transition piece 9 comprises a connector segment 16 and a platform support 17, which supports the workers' platform 15. The connector segment 16 is provided between a flange 19 of the tower 7 and a flange 20 of the support column 8. The flanges 19 and 20 are arranged parallel to each other and oriented perpendicular to a central longitudinal axis of the tower 7. The flanges 19, 20 are connected to each other by bolts 18 that extend vertically in corresponding holes 28 through the connector segment 16.

Alternatively, the flanges 19 and 20 are screwed by bolts 18 into corresponding threaded bushings embedded in the connector segment 16. Examples thereof will be given in the following.

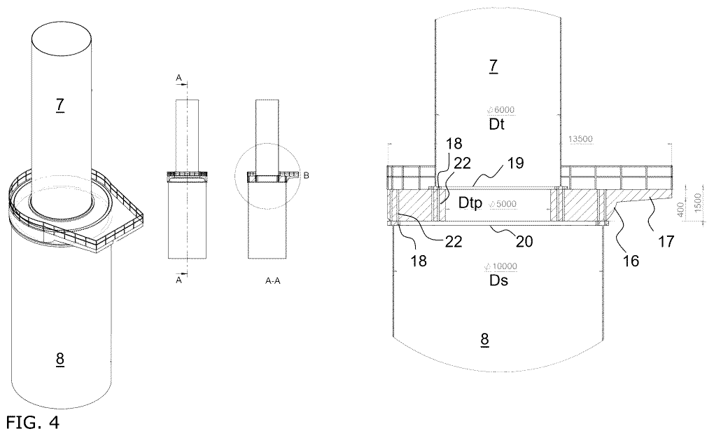

FIG. 3 illustrates a transition piece 9 between the tower support 8 and the tower 7 where the tower support 8 has a diameter Ds that is smaller than the diameter Dt of the tower. In this case, the flange 19 of the tower 7 is fastened to the transition piece 9, in particular to the connector segment 16, by bolts 18 that extend vertically through holes in the tower flange 19 from above and into corresponding threaded bushings in the connector segment 16. Correspondingly, the flange 20 of the support column 8 is fixed to the connector segment 16 by bolts 18 that extend vertically through holes in the flange 20 from below and into threaded bushings in connector segment 16. Typically, the bushings are integrated in the connector segment 16 of the transition piece 9 when it is cast in concrete.

FIG. 4 illustrates an embodiment where the support column 8 has a diameter Ds that is larger than the diameter Dt of the tower 7. Also, in this case, the corresponding flanges 19 and 20 are fixed to the connector segment 16 by bolts 18 that are fastened in threaded bushings.

And advantage of the principle of providing a transition piece 9 in the described manner is great flexibility in the shaping and in the production, which can be easily customized to the various sizes of support columns 8 and towers 7. In particular, for a certain support column 8 of fixed diameter Ds, it is possible to mount various wind turbine towers 7 with different diameters Dt by providing corresponding transition pieces 9. The transition pieces 9 are cast in enforced concrete and can even be prepared in stock for certain sizes and shapes of tower supports 8, be it in the form of a column or another shape, when the tower diameters Dt in question are already known, for example because there are standard diameters for towers 7 of different wind turbine brands.

The fact that the transition piece 9 is provided between the flanges 19 and 20 has an advantage of the height H of the transition piece 9 being relatively small, for example in the range of 1-3 meters, or even only in the range of 1-2 meters, and the corresponding requirements for material in the transition piece 9 is correspondingly small.

This is in contrast to the prior art, where transition pieces embrace a substantial portion of the upper part of the tower support, which necessitates casting of a hollow tubular structure with a cavity into which the upper portion of the tower support and/or a lower portion of the tower is accommodated.

As illustrated in FIG. 4, the platform support 17 is cast as part of the transition piece 9 and integral with the connector segment 16. However, this is not strictly necessary.

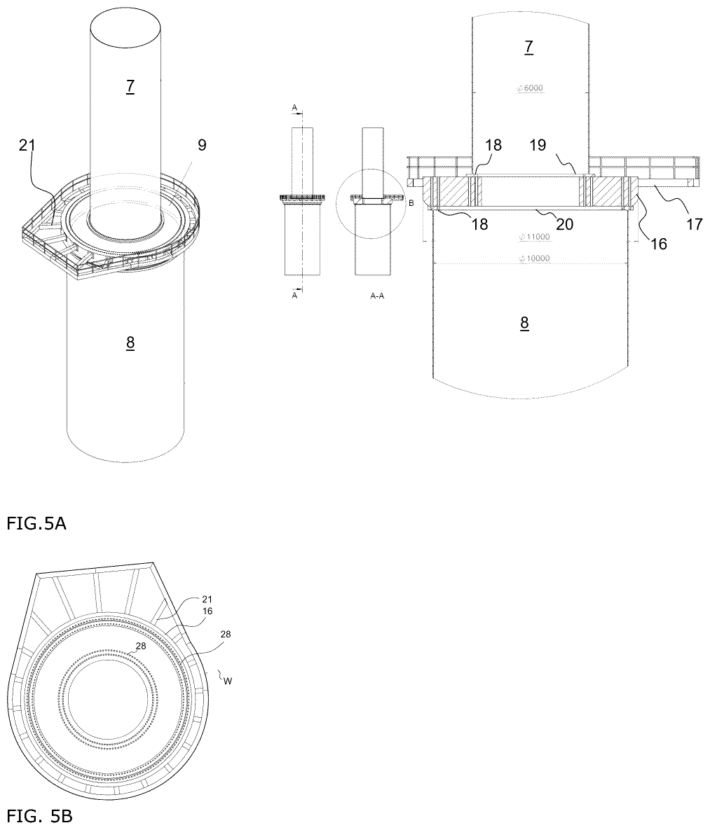

FIG. 5A in cross sectional view and FIG. 5B in top view illustrate an alternative embodiment in which the platform support 17 is provided by using bars 21 that are embedded in the connector segment 16 but extend therefrom, for example extend radially from the connector segment 16. In the illustrated case of FIG. 5A, these bars 21 are in practical embodiments covered by a platform surface. As compared to the integrally cast platform support 17 of FIG. 4, the platform structure in FIG. 5A results in a more lightweight arrangement. Illustrated in FIG. 5B are also the holes 28 for the bolts 18.

For example, the diameter Dt of the tower 7 is in the range of 6-10 m and diameter Ds of the support column in the range of 8-10 m. Examples of combinations of these are exemplified in the drawings. However, dimensions given in the drawings are exemplary and not limiting.

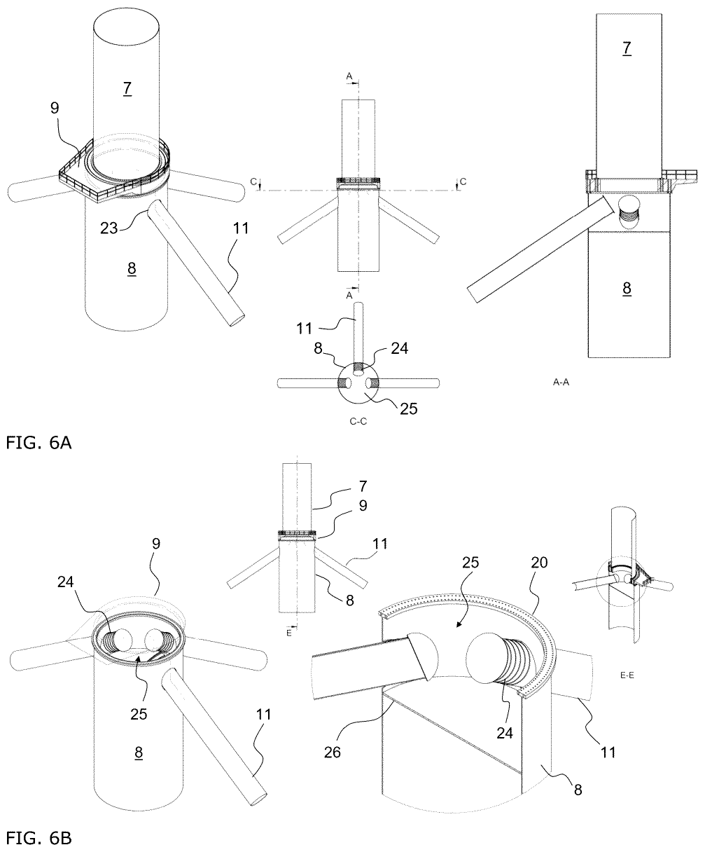

FIG. 6 illustrates an arrangement in which diagonal braces 11 are embedded in the tower 8 with one of their ends. For this type of attachment, the tower 8 is provided with three openings 23 into each of which one end of one of the diagonal braces 11 is inserted. The volume 25 into which the ends of the diagonal braces 11 are inserted is delimited by a bottom plate 26 that extends across the support column 8 laterally relatively to the central axis of the support column 8. For example, the bottom plate 26 is welded to the inner wall of the metallic support column 8. The volume 25 between the bottom plate 26 and the flange 20 of the support column 8 is filled with concrete after the insertion of the ends of the diagonal braces 11.

Advantageously and as exemplified, in order for the diagonal braces 11 to be held securely inside the concrete in the volume 25, the ends of the diagonal braces 11 are provided with sheer keys 24.

In practice, the diagonal braces 11 are inserted with their ends into the volume 25 after which the volume 25 is filled with concrete from above, for example before the transition piece 9 is placed and fixed onto the support column on top of the volume 25. Alternatively, the transition piece 9 is fastened to the tower 8 on the flange 20 prior to filling the volume 25 with concrete. This is possible because the transition piece 9 has a central opening through which concrete can be inserted into the volume 25 from above.

What is claimed is:

1. An offshore wind turbine installation, comprising:
a wind turbine comprising a tower having a tower flange at a lower end of the tower;
a support structure for supporting the wind turbine in offshore conditions, the support structure comprising a tower support having a support flange;
a concrete-cast transition piece between the support flange and the tower flange, the transition piece on its lower side in mechanical contact with the support flange and supported by the support flange, and the tower flange on its lower side in mechanical contact with an upper side of the transition piece and supported by the transition piece;
wherein the support flange is at an upper end of the tower support, and the support flange and the tower flange each comprise holes for bolts extending therethrough, the bolts directly or indirectly holding the tower flange to the tower support flange with the transition piece in between;
wherein (A) each of the bolts extends through both the support flange and the tower flange for pulling the support flange and the tower flange towards each other by the bolts with the transition piece sandwiched in between or (B) a first number of the bolts extends through the tower flange into first threaded bushings embedded inside concrete of the transition piece and a second number of the bolts extends through the support flange into second threaded bushings embedded inside concrete of the transition piece, thereby bolting the tower flange and the support flange to opposite sides of the transition piece.

2. The installation according to claim 1, wherein at least some of the bolts also extend through holes in the transition piece.

3. The installation according to claim 1, wherein the support flange and the tower flange each extend radially in a plane perpendicular to a central longitudinal axis of the tower.

4. The installation according to claim 1, wherein the bolts, which extend through the holes in the flanges, are oriented with their longitudinal axes parallel to a central axis of the tower.

5. The installation according to claim 1, wherein in (B) the tower has a first diameter Dt and the support structure has a support diameter Ds, wherein Ds is different from Dt, wherein the tower flange comprises a first number of holes along a first circle, and the support structure comprises a second number of holes along a second circle with a second diameter, which is different from the first diameter, and wherein the first number of bolts extends from below the support flange through the first number of holes and into a first cooperating number of bushings inside the transition piece, and wherein the second number of the bolts extends from above the tower flange through the second number of holes and into a second cooperating number of bushings inside the transition piece.

6. The installation according to claim 1, wherein the support structure is formed as a tetrahedron with a triangular base to which the tower support is fixed and with diagonal braces extending from the triangular base inclined upwards to form a tetrahedral structure with the tower support.

7. The installation according to claim 6, wherein the diagonal braces are embedded in concrete in a volume contained in the upper end of the tower support, and each of the diagonal braces extends with one of its ends into the volume through an opening in the tower support.

8. The installation according to claim 1, wherein the transition piece is located entirely above a water surface.

9. The installation according to claim 1, wherein the transition piece comprises a platform for workers.

10. The installation according to claim 1, wherein the tower support and the tower are steel columns to which the support flange and the tower flange are welded, respectively.

11. The installation according to claim 1, wherein the transition piece extends over no more than a height H, when measured in a direction parallel to the central axis of the tower, wherein H is less than half of a diameter Dt of the tower.

12. The installation according to claim 11, wherein H is in a range of 1-3 meters, and wherein a distance between the support flange and the tower flange with the transition piece therebetween is in a range of 1-3 meters.
